(19) United States
(12) Patent Application Publication
(10) Pub. No.: US 2019/0277466 A1
(43) Pub. Date: Sep. 12, 2019

(54) Light Fixture Bracket

(71) Applicant: Enlighten Luminaires, Paramus, NJ (US)

(72) Inventor: Andrew Peck, Mahwah, NJ (US)

(21) Appl. No.: 15/918,039

(22) Filed: Mar. 12, 2018

(51) Int. Cl. F21S 8/04

(52) U.S. Cl. CPC F21S 8/043; F21V 21/005

(57) ABSTRACT

A bracket for attaching lights to a ceiling, such as a drop ceiling, is disclosed. The bracket has an L-shaped upper section, a connector, and an upside down U-shaped lower section, with serifs extending inward only. Adjacent to the connector is a space or portal adapted for receipt of a portion of the ceiling. Thus, the bracket sits both above and below the ceiling and can be placed on to the ceiling without need of additional tools. The bracket fits, for example, snugly around a grid used to support ceiling tiles, the bracket being between a ceiling tile and grid, with lights attached to a lower side of the bracket.

### FIELD OF THE DISCLOSED TECHNOLOGY

This invention is related to light fixture brackets and, more specifically, to a bracket installed within a ceiling.

### BACKGROUND OF THE DISCLOSED TECHNOLOGY

Light fixtures are often difficult to install, requiring the running of electrical cables and attachment of screws through various parts of a ceiling or wall. When using a drop ceiling, one must additionally secure the fixture or part of the drop ceiling with wires or lengths of metal attached above the drop-ceiling because the light fixture is simply too heavy to be safely supported by the drop ceiling.

There has been a long felt need to be able to add lights to a ceiling simply and easily. Such an installation should ideally be performable by anyone and carried out without having to drill or fasten together parts, and without taking much time.

### SUMMARY OF THE DISCLOSED TECHNOLOGY

A light fixture bracket of embodiments of the disclosed technology has an above-ceiling section and a below-ceiling section. The above-ceiling section has an upper horizontal section adapted for engagement with an upper side of a ceiling and an upper vertical section perpendicular to the horizontal section fixedly attached to an end of the upper horizontal section. A below-ceiling section has a middle horizontal section in parallel with the upper horizontal section and a first lower vertical section and a second lower vertical section, each attached to an end of the middle horizontal section. A first lower horizontal section and a second lower horizontal section are perpendicularly and fixedly attached, respectively, to the first lower vertical section and the second lower vertical section.

longitudinally extending portal is formed between the upper horizontal section and the middle horizontal section, in embodiments of the disclosed technology. This section has a height less than 1%, 5%, 10%, or 15% wider than a portion of a ceiling it is adapted to receive there-in. A further channel can be defined by, and/or be between, the first lower horizontal section and the second lower horizontal section. This channel, in embodiments of the disclosed technology, opens into a portal defined by the first lower vertical section, the second lower vertical section, the middle horizontal section, the first lower horizontal section, and/or the second lower horizontal section. The upper vertical section, in some embodiments, is broken into two portions of equal length, with a space between the two portions. In this space, a part of a ceiling grid passes in some embodiments.

A method of installing the light fixture bracket of embodiments of the disclosed technology is carried out by placing an upper horizontal section of the light fixture bracket above a portion of a ceiling, and resting the upper horizontal section on the portion of the ceiling. Then, or prior to, the “resting” one attaches a middle horizontal section, such that it is parallel with the upper horizontal section, but below a space for the ceiling. The middle horizontal section being (connected to, or forming, a unitary structure with a bracket that has sides and middle sections with a portal between the middle sections.

A longitudinal portal between the upper horizontal section and the middle horizontal section has within it, in some embodiments, a portion of the ceiling. The attaching takes place after the step of resting the upper horizontal section on the portion of the ceiling, in some embodiments. In other embodiments, the attaching takes place before the step of resting the upper horizontal section on the ceiling.

The longitudinal portal is defined by a connecting piece between the upper horizontal section and the middle horizontal section, in some embodiments. The light fixture bracket further has two distinct upper vertical sections fixedly attached perpendicularly to the upper horizontal section, in some embodiments. A section of the ceiling, which extends perpendicularly to the portion of the ceiling on which the upper horizontal section rests, passes between the two distinct upper vertical sections, in embodiments of the disclosed technology. Individual ceiling tiles of the ceiling extend to an edge of one of the two distinct upper vertical sections once the bracket is installed, in some embodiments.

Any device or step to a method described in this disclosure can comprise, or consist of, that which it is a part of, or the parts which make up the device or step. The term “and/or” is inclusive of the items which it joins linguistically and each item by itself.

### BRIEF DESCRIPTION OF THE DRAWINGS

FIG. 1 is a side view of a bracket of an embodiment of the disclosed technology.

FIG. 2 is a bottom perspective view thereof with light fixtures attached.

FIG. 3 is a top perspective view thereof.

FIG. 4 is a bottom perspective view thereof.

FIG. 5 shows various additional side views of the bracket.

### DETAILED DESCRIPTION OF EMBODIMENTS OF THE DISCLOSED TECHNOLOGY

A bracket for attaching lights to a ceiling, such as a drop ceiling, is disclosed. The bracket has an L-shaped upper section, a connector, and an upside down U-shaped lower section with serifs extending inward only. Adjacent to the connector is a space or portal adapted for receipt of a portion of the ceiling. Thus, the bracket sits both above and below the ceiling and can be placed on to the ceiling without the need of additional tools. The bracket fits, for example, snugly around a grid used to support ceiling tiles, the bracket being between a ceiling tile and grid with lights attached to a lower side of the bracket.

Embodiments of the disclosed technology are described below, with reference to the figures provided.

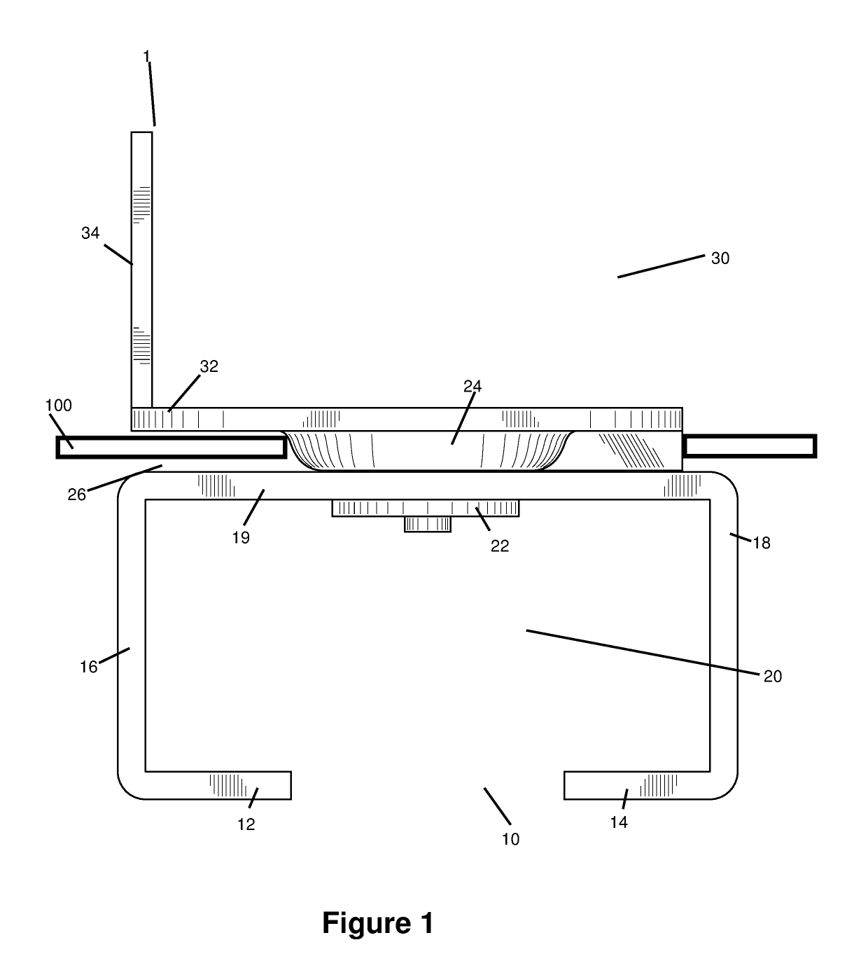

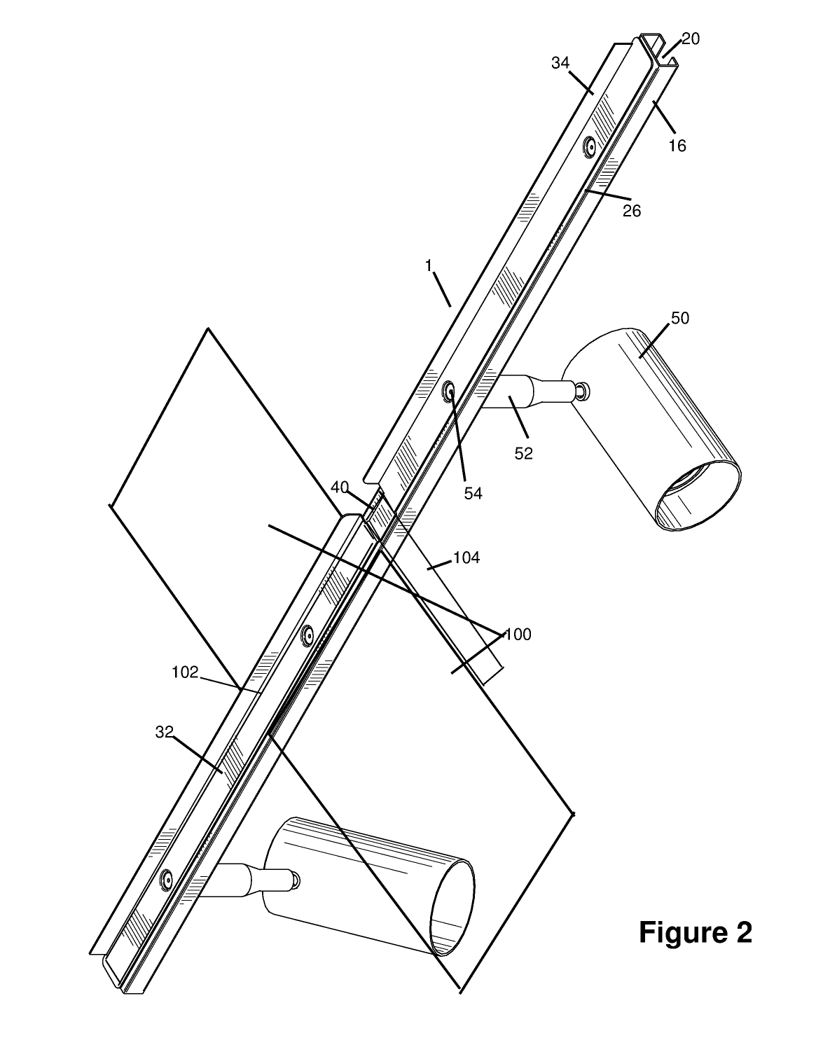

Discussing FIG. 2 first, FIG. 2 is a bottom perspective view of FIG. 1 with light fixtures attached. Here, a light fixture 50, by way of its stem 52, has been inserted into a channel 20 and is attached into the channel 20 of the bracket. It can additionally be fastened through the bracket by way of a fastener 54 on the other side of the bracket 1. A plurality of ceiling tiles 100 can be placed to abut the bracket 1 and a drop ceiling grid with a row 102 in the grid, and column 104 in the grid can be placed within/adjacent to/and/or abutting a top side 32 of the bracket 1. In other embodiments, the bracket 1 replaces some or all of the grid pieces, such as just a row 102, while the column 104 passes through a portion 40 of the bracket 1 where there is a break in an upper vertically extending piece 34. As such, the bracket 1 can be in place of part of the ceiling grid, or be under or adjacent to the ceiling grid, and attach to the ceiling grid, above and below, as will be discussed with reference to FIG. 1.

FIG. 1 is a side view of a bracket of an embodiment of the disclosed technology. In this side view one can see the ceiling 100 which, in this figure, is part of a ceiling tile. However, the ceiling shown can also be representative of a portion of a grid of a drop ceiling, a solid ceiling with a portal where the bracket 1 passes through, and/or a ceiling tile. Note that the ceiling 100 is a thicker rectangular box on either side of the bracket, as shown in the figure.

The bracket 1 has an upper section at and above the ceiling 100, and a lower section below the ceiling 100. The upper section rests on the ceiling 100 in some embodiments and is above the ceiling. The lower section is below the ceiling 100. The lower section is, in embodiments, a “belt staple”-shaped bracket, with lower horizontal portions 12 and 14 ending at, and opening into, a portal 10. Between these lower horizontal portions 12 and 14, and a middle horizontal section 19, is a channel 20, which is further defined by left and right lower vertical walls 16 and 18. The terms “channel” and “portal” are spaced between other solid objects, whereas the terms “section,”,“portion,” and other terms, used to define part of the bracket itself, refer to/are defined as solid objects (which may have portals there-in). The lower portion of the bracket 1 has, in some embodiments, a fastener 22 used to fasten either, or both of, the middle horizontal section 19 to the upper horizontal section 32, or a light fixture to the bracket 1.

The upper section of the bracket 1 comprises an upper horizontal section 32 and upper vertical section 34, which are connected to each other at a right angle, in embodiments of the disclosed technology. The upper horizontal section 32 rests or abuts a portion of a ceiling 100, such as a ceiling tile or ceiling grid. A “ceiling grid,” for purposes of this disclosure, is defined as a plurality of rows and columns of solid material used to support ceiling tiles. A connecting region 24 connects the upper region (32 and 34) of the bracket 1 to the lower region thereof. The lower region comprises the middle horizontal section 19 and the parts there-below. For purposes of this disclosure, “top” and “upper” refer to a direction in which the bracket 1 is often used with the channel 20 at a “lower” or “bottom” side. As such, the portion above the ceiling is the “top” side, and the portion below the ceiling is the “bottom” side.

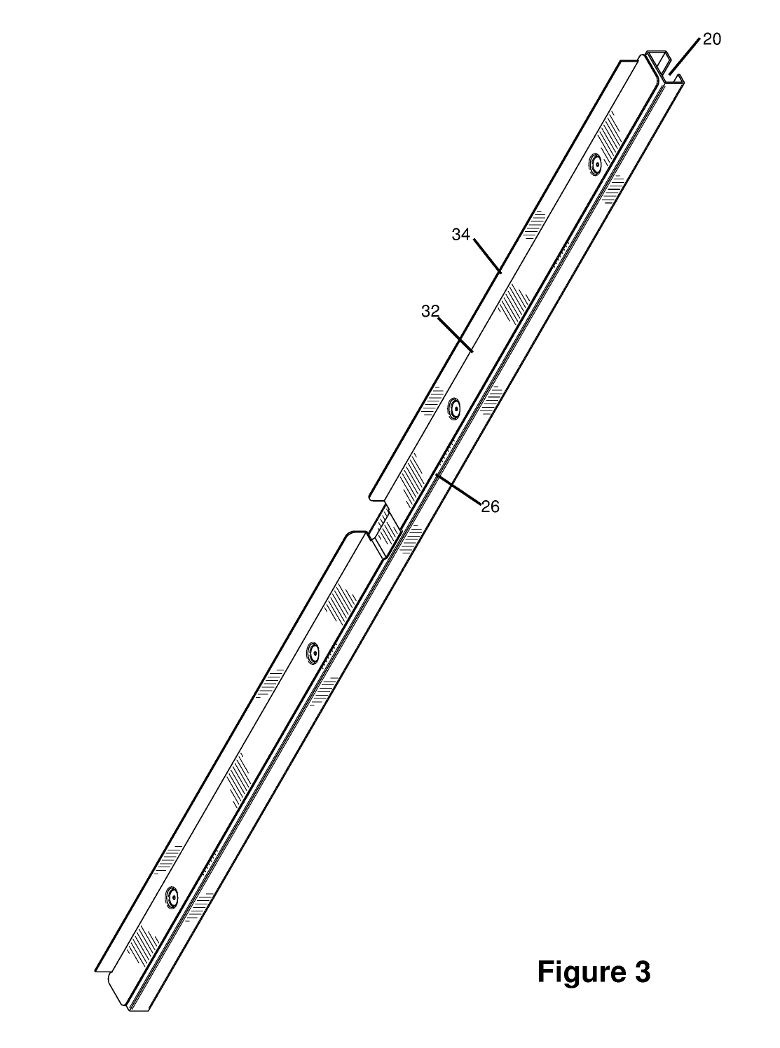

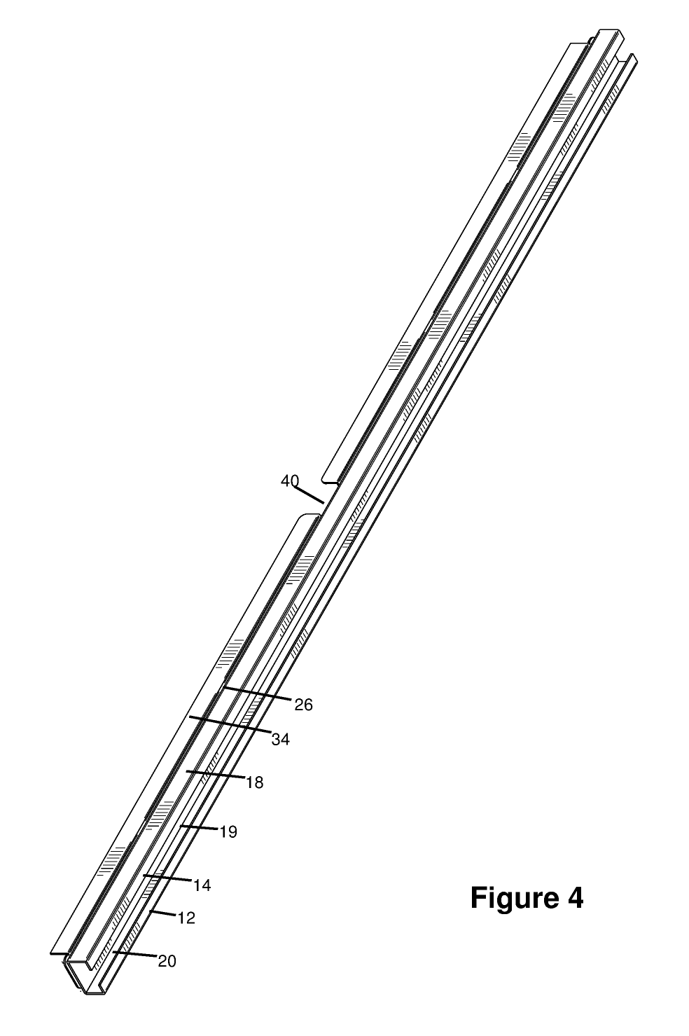

FIG. 3 is a top perspective view thereof. FIG. 4 is a bottom perspective view thereof. On the bottom side, one can see channel 20, to which a light fixture can be attached and then held gravitationally by the lower horizontal sections and 14.

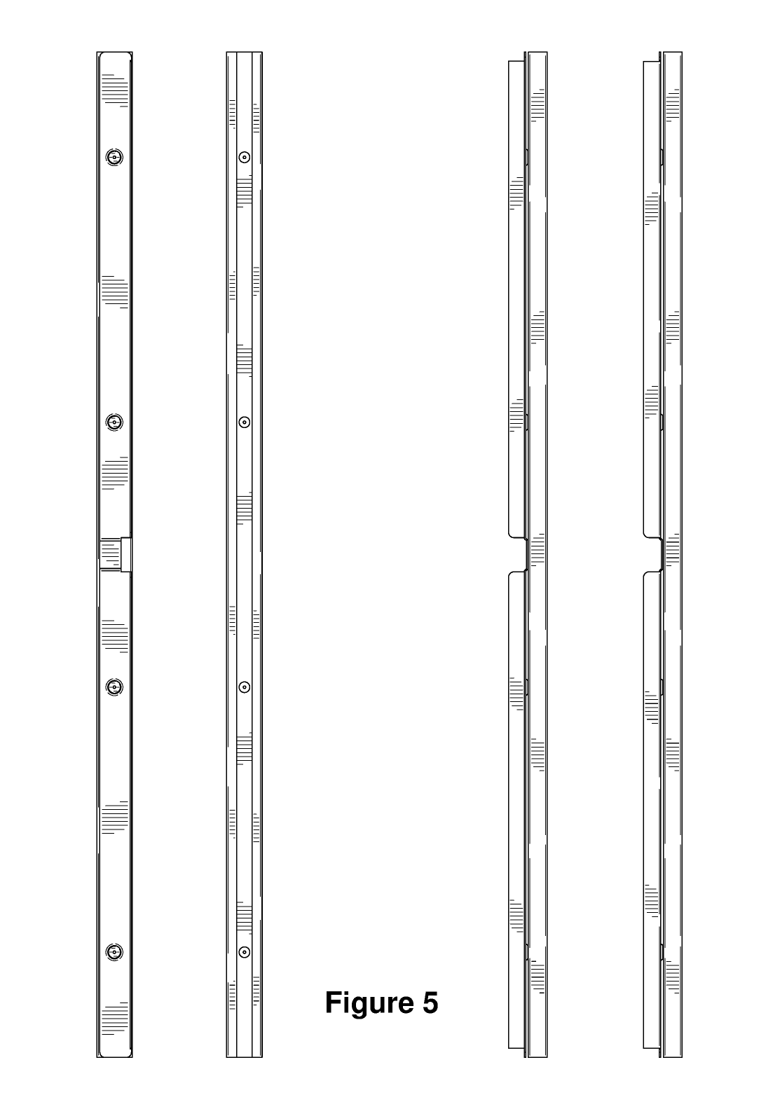

FIG. 5 shows various additional side views of the bracket.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. A light fixture bracket, comprising:
an above-ceiling section with:
an upper horizontal section adapted for engagement with an upper side of a ceiling;
an upper vertical section perpendicular to said horizontal section fixedly attached to an end of said upper horizontal section;
a below-ceiling section with:
a middle horizontal section in parallel with said upper horizontal section;
a first lower vertical section and a second lower vertical section, each attached to an end of said middle horizontal section.
a first lower horizontal section and a second lower horizontal section perpendicularly and fixedly attached, respectively, to said first lower vertical section and said second lower vertical section.

2. The light fixture bracket of claim 1, wherein a longitudinally extending portal is formed between said upper horizontal section and said middle horizontal section.

3. The light fixture bracket of claim 2, wherein said longitudinally extending portal has a height less than 15% wider than a portion of a ceiling it is adapted to receive therein.

4. The light fixture bracket of claim 3, further comprising a channel defined by and between said first lower horizontal section and said second lower horizontal section.

5. The light fixture bracket of claim 4, wherein said channel opens into a portal defined by said first lower vertical section, said second lower vertical section, said middle horizontal section, said first lower horizontal section, and said second lower horizontal section.

6. The light fixture bracket of claim 5, wherein said upper vertical section is broken into two portions of equal length, with a space between said two portions.

7. A method of installing a light fixture bracket, comprising:
placing an upper horizontal section of said light fixture bracket above a portion of a ceiling;
resting said upper horizontal section rests on said portion of said ceiling;
attaching a middle horizontal section in parallel with said upper horizontal section, such that said middle horizontal section is below a space for said ceiling, said middle horizontal section being a bracket with sides and middle sections, with a portal between said middle sections.

8. The method of claim 7, wherein a longitudinal portal between said upper horizontal section and said middle horizontal section has there-within said portion of said ceiling.

9. The method of claim 8, wherein said attaching takes place after said step of resting said upper horizontal section on said portion of said ceiling.

10. The method of claim 8, wherein said attaching takes place before said step of resting said upper horizontal section on said portion of said ceiling.

11. The method of claim 7, wherein said longitudinal portal is defined by a connecting piece between said upper horizontal section and said middle horizontal section.

12. The method of claim 11, wherein said light fixture bracket further comprises two distinct upper vertical sections fixedly attached perpendicularly to said upper horizontal section.

13. The method of claim 12, wherein a section of said ceiling extends perpendicularly to said portion of said ceiling, on which said upper horizontal section rests, passes between said two distinct upper vertical sections.

14. The method of claim 12, wherein individual ceiling tiles of said ceiling extend to an edge of one of said two distinct upper vertical sections.

15. The method of claim 14, wherein said longitudinal portal has a height from top to bottom less than 10% more than a portion of a ceiling it is adapted to receive therein.
